(19) United States
(12) Patent Application Publication
(10) Pub. No.: US 2024/0199792 A1
(43) Pub. Date: Jun. 20, 2024

(54) TWO-COMPONENT CURABLE COMPOSITIONS

(71) Applicant: Henkel AG & CO. KGaA, Duesseldoft (DE)

(72) Inventor: Stanley Shengqian Kong, Hillsborough, NJ (US)

(21) Appl. No.: 18/410,070

(22) Filed: Jan. 11, 2024

Related U.S. Application Data
(63) Continuation of application No. PCT/US2022/072422, filed on May 19, 2022.
(60) Provisional application No. 63/222,144, filed on Jul. 15, 2021.

(51) Int. Cl. C08G 59/42; C08G 59/24

(52) U.S. Cl. CPC C08G 59/4223; C08G 59/245; C08G 2150/00; C08G 2170/00; C08G 2190/00

(57) ABSTRACT

Room temperature, two-component curable compositions and their uses are described. The curable compositions are alternative to isocyanate systems and are kinetically tunable to cure within seconds to months. The curable compositions are particularly useful as coatings, adhesives, sealants, and elastomers for consumer packages including food packages.

### FIELD OF THE INVENTION

The invention relates to room temperature, two-component curable compositions and uses thereof. The curable compositions are alternative to isocyanate systems and are kinetically tunable to cure within about 48 hours. The curable compositions are particularly useful as coatings, adhesives, sealants, and elastomers for consumer packages including food packaging.

### BACKGROUND OF THE INVENTION

Room temperature, two-component curable compositions are useful as coatings, adhesives, sealants, and elastomers in a broad range of applications, including electrical and electronic device, constructions, vehicles, medical devices, appliances, and food packages, etc. Typically, curable compositions require curing profiles that are appropriate for the target application. Cost is also a concern, but safety for the consumer and emphasis on sustainability are becoming leading factors for developing novel curable compositions.

Isocyanates are typically used as two-component room temperature curable polyurethane compositions; however, problems associated with safety and environmental concerns with this system requires an alternative solution. For example, polyurethanes are common components in adhesives, inks and coatings for flexible packaging. Currently, about 90% of all adhesives in flexible packages are polyurethane-based. Primary aromatic amines (PAA) can form when the polyurethane-based adhesive is not fully cured before packing it with food. In such cases, unreacted residual isocyanate monomers in the adhesive will react with the moisture in food and PAA forms. They can migrate and remain in food and lead to human, pet or livestock consumption. Certain PAAs present a toxicological concern as they have been identified as carcinogenic.

Isocyanates that are typically used with polyurethanes are classified as potential human carcinogens and known carcinogens for animals. In addition, isocyanates present a safety concern in workplace. According to OSHA (Occupational Safety and Health Administration), health effects of isocyanate exposure include irritation of skin and mucous membranes, chest tightness, and difficult breathing. The main effects of hazardous exposures are occupational asthma and other lung problems, as well as irritation of the eyes, nose, throat, and skin.

One alternative to isocyanate system is a silicon-based system with hydrosilation of a hydridosilyl compound with a vinylsiyl compound or moisture cure of alkoxy silane or acetoxy silane on various backbones, e.g., silicones, polyacrylates, polyethers, polyesters, polycarbonates, hydrocarbons. However, they are high in monetary cost. For hydrosilation cure systems, heavy metal catalysts are necessary, but their reactivities are susceptible to poisoning by other impurities in the system, thus leading to slow reaction kinetics. For moisture curable systems, the curing kinetics depend on moisture migration. In addition, methanol or acetic acid are generated as a by-product in many cases, leading to safety concerns.

Another alternative to isocyanate system is utilizing Michael Addition with an electron deficient compound (e.g., acrylate, maleimide) with a nucleophile (e.g., thiol or amine). Thiols and amines typically have strong, unpleasant odors, which make them undesirable for food packaging.

Yet another alternative to fast two component curable system is anaerobic acrylate/methacrylate system; however, most compatible catalysts to these anaerobic systems are considered to be toxic. Again, such systems are not desirable for food packages.

Epoxy-based systems with thiol and amine curatives are also possible room temperature curable adhesives; however, cure kinetics could be sluggish at room temperature. In addition, thiol and amine curative odor presents a challenge for food packaging.

Accordingly, there is a need in the art for an alternative room temperature curable system that are kinetically tunable other than an isocyanate system. The current invention fulfills this need.

### BRIEF SUMMARY OF THE INVENTION

The invention provides room temperature curable compositions and uses thereof for coatings, adhesives, sealants, and elastomers (CASE). In particular, for bonding and assembling industrial and consumer packages. In use, these include mobile devices, computers, televisions/monitors, sealants and caulking materials, gap filler thermal interface materials, packaging, including food packages, pressure sensitive adhesives, and the like. These compositions can also be combined with other curing systems (e.g., UV, anaerobic, moisture cure) to create dual cure systems.

One aspect of the invention is directed to a two-component curable composition comprising:
a) an oxirane or oxetane functionalized component and
b) a multifunctional acid derivative having a structure of (i)

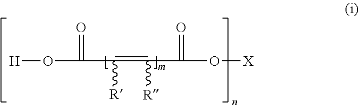

wherein R′ and R″, independently are H or R′—═—R″ is an aromatic ring, and may further contain substitutions on the aromatic ring; m=0 or 1, n is a positive integer from 2 to 100, and X is a multifunctional radical backbone, and

wherein the multifunctional acid derivative is either prepared from a diacid precursor having a structure of (ii) which has a pKa1 of less than 3, or prepared from the corresponding anhydride of the diacid (ii).

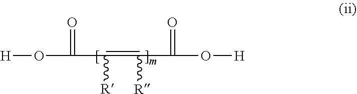

Another aspect of the invention is directed to a two-component curable composition comprising:
a) an epoxidized oil prepared from a renewable triglyceride compound and
b) a multifunctional acid derivative having a structure of (i)

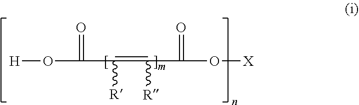

wherein R′ and R″, independently are H or R′—═—R″ is an aromatic ring, and may further contain substitutions on the aromatic ring; m=0 or 1, n is a positive integer from 2 to 100, and X is a multifunctional radical backbone, and

wherein the multifunctional acid derivative is prepared from a diacid precursor having the structure of (ii), which has a pKa1 of less than 3, or prepared from the corresponding anhydride of the diacid (ii)

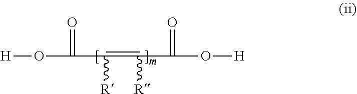

Yet another aspect of the invention is directed to a two-component curable composition comprising:
a) oxirane or oxetane functionalized component and
b) di- or tri-carboxylic acid having a pKa1 less than 3.0 and selected from the group consisting of oxalic acid, maleic acid, fumaric acid, phthalic acid, trimellitic acid, and derivatives thereof.

Another aspect of the invention is directed to an article of manufacture comprising the two-component curable compositions, which is a coating, adhesive, sealant, or elastomer.

### BRIEF DESCRIPTION OF THE DRAWING

FIG. 1 is a Size Exclusion Chromatography plot of reaction adducts of (1) bisphenol A diglycidyl ether and oxalic acid (B-OA, solid line, Example 10), and (2) cycloaliphatic epoxy and oxalic acid (S-OA, dotted line, Example 9).

### DETAILED DESCRIPTION OF THE INVENTION

Unless otherwise defined, all technical and scientific terms used herein have the same meaning as commonly understood by one of ordinary skill in the art. In case of conflict, the present document, including definitions, will control. Preferred methods and materials are described below, although methods and materials similar or equivalent to those described herein can be used in practice or testing of the present disclosure. All publications, patent applications, patents and other references mentioned herein are incorporated by reference in their entirety. The materials, methods, and examples disclosed herein are illustrative only and not intended to be limiting.

As used herein, the term “comprising” may include the embodiments “consisting of and “consisting essentially of.” The terms “comprise(s),” “include(s),” “having,” “has,” “can,” “contain(s),” and variants thereof, as used herein, are intended to be open-ended transitional phrases, terms, or words that require the presence of the named ingredients/steps and permit the presence of other ingredients/steps. However, such description should be construed as also describing compositions or processes as “consisting of and “consisting essentially of the enumerated ingredients/steps, which allows the presence of only the named ingredients/steps, along with any impurities that might result therefrom, and excludes other ingredients/steps.

Numerical values herein, particularly as they relate to polymers or polymer compositions, reflect average values for a composition that may contain individual polymers of different characteristics. Furthermore, unless indicated to the contrary, the numerical values should be understood to include numerical values which are the same when reduced to the same number of significant figures and numerical values which differ from the stated value by less than the experimental error of conventional measurement technique of the type described in the present application to determine the value.

All ranges disclosed herein are inclusive of the recited endpoint and independently combinable (for example, the range of “from 2 to 10” is inclusive of the endpoints, 2 and 10, and all the intermediate values). The endpoints of the ranges and any values disclosed herein are not limited to the precise range or value; they are sufficiently imprecise to include values approximating these ranges and/or values. As used herein, approximating language may be applied to modify any quantitative representation that may vary without resulting in a change in the basic function to which it is related. Accordingly, a value modified by a term or terms, such as “about,” may not be limited to the precise value specified, in some cases. In at least some instances, the approximating language may correspond to the precision of an instrument for measuring the value. The modifier “about” should also be considered as disclosing the range defined by the absolute values of the two endpoints. For example, the expression “from about 2 to about 4” also discloses the range “from 2 to 4.” The term “about” may refer to plus or minus 10% of the indicated number. For example, “about 10%” may indicate a range of 9% to 11”, and “about 1” may mean from 0.9-1.1. Other meanings of “about” may be apparent from the context, such as rounding off, so, for example “about 1” may also mean from 0.5 to 1.4.

As used herein, a polymer or an oligomer is a macromolecule that consists of monomer units is equal or greater than about one monomer unit. Polymer and oligomer, or polymeric and oligomeric, are used interchangeably here in the invention.

As used herein, the term “alkyl” refers to a monovalent linear, cyclic or branched moiety containing C1 to C24 carbon and only single bonds between carbon atoms in the moiety and including, for example, methyl, ethyl, propyl, isopropyl, n-butyl, sec-butyl, isobutyl, tert-butyl, n-pentyl, n-hexyl, heptyl, 2,4,4-trimethylpentyl, 2-ethylhexyl, n-octyl, n-nonyl, n-decyl, n-undecyl, n-dodecyl, n-hexadecyl, and n-octadecyl. Additionally, alkyl groups may further contain unsaturations and/or hetero atoms in the main chain or side chain.

As used herein, the term “aryl” refers to a monovalent unsaturated aromatic carbocyclic group of from 6 to 24 carbon atoms having a single ring (e.g., phenyl) or multiple condensed (fused) rings, wherein at least one ring is aromatic (e.g., naphthyl, dihydrophenanthrenyl, fluorenyl, or anthryl). Preferred examples include phenyl, methyl phenyl, ethyl phenyl, methyl naphthyl, ethyl naphthyl, and the like.

As used herein, the term “alkoxy” refers to the group —O—R, wherein R is alkyl as defined above.

As used herein, the above groups may be further substituted or unsubstituted. When substituted, hydrogen atoms on the groups are replaced by substituent group(s) that is one or more groups independently selected from alkyl, alkenyl, alkynyl, cycloalkyl, cycloalkenyl, cycloalkynyl, aryl, heteroaryl, heteroalicyclyl, aralkyl, heteroaralkyl, (heteroalicyclyl)alkyl, hydroxy, protected hydroxyl, alkoxy, aryloxy, acyl, ester, mercapto, alkylthio, arylthio, cyano, halogen, carbonyl, thiocarbonyl, O-carbamyl, N-carbamyl, O-thiocarbamyl, N-thiocarbamyl, C-amido, N-amido, S-sulfonamido, N-sulfonamido, C-carboxy, protected C-carboxy, O-carboxy, isocyanato, thiocyanato, isothiocyanato, nitro, silyl, sulfenyl, sulfinyl, sulfonyl, haloalkyl, haloalkoxy, trihalomethanesulfonyl, trihalomethanesulfonamido, and amino, including mono- and di-substituted amino groups, and the protected derivatives thereof. In case that an aryl is substituted, substituents on an aryl group may form a non-aromatic ring fused to the aryl group, including a cycloalkyl, cycloalkenyl, cycloalkynyl, and heterocyclyl.

The term, “room temperature cure” herein refers to crosslinking of system at ambient temperature ranging from about 20 to about 30° C.

Two-component curable compositions cure via a chemical reaction. They require each component of the two components to be dosed in proper amounts and mixed for proper curing at ambient temperature. Once mixed, they can be used to join substates together for a bond in various articles. The two-component curable compositions can be kinetically tuned to cure within 48 hours.

One of the two-component curable composition, or the first component, is an oxirane or oxetane functionalized component. The oxirane functionalized component may be glycidyl epoxy resin or a non-glycidyl epoxy resin. For non-glycidyl epoxy resin, it is preferable to be an aliphatic epoxy resin. For glycidyl epoxy resin, it is preferable for the epoxy to have glycidyl-ether (z), glycidyl-ester (y), glycidyl-carbonate (x) or glycidyl urethane (w) functional group.

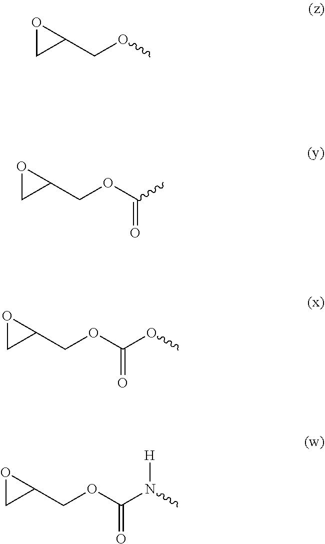

The term “oxetane compound” generally refers to any small molecule, oligomer or polymer carrying an oxetane functionality. The oxtane compound generally has the structure (v),

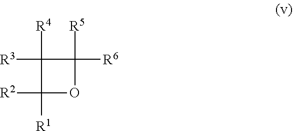

where R¹, R², R³, R⁴, R⁵, and R⁶ are selected from the group consisting of hydrogen, and alkyl, haloalkyl, alkoxy, aryloxy. aryl, ester, thio-ester, and sullide groups. The oxetane compound can be mono- or multifunctional, and can contain other reactive functionalities, e.g., oxirane, in the same molecule

In another embodiment, the oxetane starting component is a urethane oxetane and its isomers.

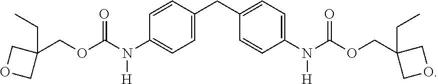 [SMILES: CCC1(COC(=O)Nc2ccc(Cc3ccc(NC(=O)OCC4(CC)COC4)cc3)cc2)COC1]

In yet another embodiment, a polymeric methylene diphenyl diisocyanate is reacted with trimethylolpropane oxetane to generate a multifunctional oxetane.

For applications that require less toxicity than bisphenol-A diglycidyl ether, the following starting components are preferably used. In addition, oligomers derived from these epoxies may also be used to decrease toxicity,

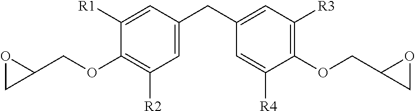

wherein R1, R2, R3 and R4 are alkyl groups as described earlier. Example of a useful monomer is shown below, when R1, R2, R3, and R4 are methyl,

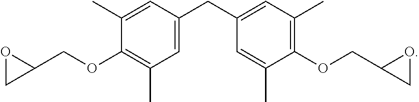 [SMILES: Cc1cc(Cc2cc(C)c(OCC3CO3)c(C)c2)cc(C)c1OCC1CO1]

In another embodiment, the epoxy functional group of the oxirane or oxetane functionalized component is attached to a polymeric backbone. The polymeric backbone is non-limiting, and preferably is a silicone, polybutadiene, 1,4-polyisoprenes, polyether, polyester, polyurethane, polycarbonate, polyacrylate, or mixtures thereof.

In another embodiment, the first component is an epoxidized oil prepared from a renewable triglyceride compound. Currently, renewable triglyceride compounds may be oils extracted from soybean, high oleic soybean, palm, rape/canola, corn, cottonseed, linseed, linola, olive, rice, safflower, sesame, sunflower, and mixtures thereof. As new discoveries occur, this list of renewable oils and plants will expand, and can be utilized as substitutes. Soybean oil, high oleic soybean oil, rape/canola oil or palm oil are particularly preferred to form renewable triglyceride compound.

The second of the two-component curable composition is a multifunctional acid derivative. This multifunctional acid derivative has a structure of (i)

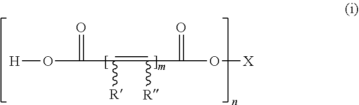

where R′ and R″, independently are H or R′—═—R″ is an aromatic ring, and may further contain substitutions on the aromatic ring; m=0 or 1, n is a positive integer from 2 to 100, and X is a multifunctional radical backbone. The multifunctional acid derivative is prepared from a diacid precursor having the structure of (ii), which has a pKa1 of less than 3

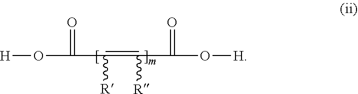

The multifunctional acid derivative can also be prepared from the corresponding anhydride of the diacid

The multifunctional acid derivative is preferably derivatives of oxalic acid maleic acid derivative, fumaric acid derivative or phthalic acid or trimellitic acid derivative.

In another embodiment, the multifunctional acid derivative is a di- or tri-carboxylic acid having a pKa 1 less than 3.0. The di- or tri-carboxylic acid is preferably selected from the group consisting of oxalic acid (pKa1=1.3), maleic acid (pKa1=1.9), fumaric acid (pKa1=3.0), phthalic acid (pKa1=2.9), trimellitic acid (pKa1=2.52) and derivatives thereof.

The ratio of the reactive functionality of the first component to the reactive functionality of the second component ranges from 1:10,000 to 10,000:1, preferably from about 2:1 to 1:2.

When the first component is an oxirane compound, the reaction of the first and the second components is expected to follow the scheme below, although some homopolymerization of the epoxy functionality is expected.

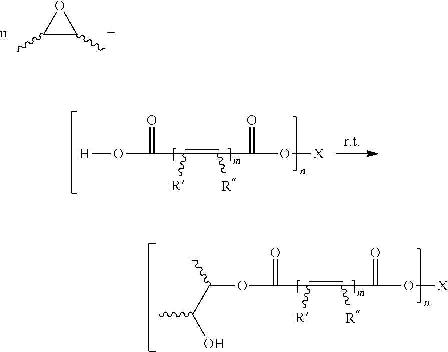

A similar reaction is expected when the first component is an oxetane compound. Heat may be added to facilitate this reaction.

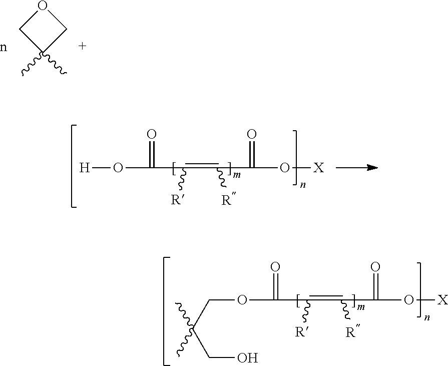

Alternatively, alcohol-anhydride ring opening, acid-epoxy ring opening or transesterification are different approaches to synthesize the multifunctional acid curatives.

The two-component curable composition may optionally comprise a tackifier, plasticizer, catalyst, curing agent, solvent or additive. Each of these optional ingredients may be added to either the first or the second component.

The tackifier may be any typical resins, e.g., rosins and their derivates, terpenes and modified terpenes, aliphatic, cycloaliphatic and aromatic resins (C5 aliphatic resins, C9 aromatic resins, and C5/C9 aliphatic/aromatic resins), hydrogenated hydrocarbon resins, and their mixtures, terpene-phenol resins (TPR, used often with ethylene-vinyl acetate adhesives)), novolacs, and the like.

The plasticizer may be ortho-phthalates, trimellitates, adipates, sebacates, or bio-based plasticizers, such as glycerol triacetate, alkyl citrates, vegetable oil based-plasticizers. Other plasticizers include azelates, dibenzoates, terephthalates, 1,2-cyclohexane dicarboxylic acid diisononyl ester, alkyl sulphonic acid phenyl ester, organophosphates, glycols and polyethers, as well as polymeric plasticizers.

The catalysts may be amine-based and its derivatives, phosphorous compounds, acids, metal complexes, and the like.

Solvents include ethyl acetate, methyl acetate, acetone, methyl isobutyl ketone, ethers, ethanol, hexane, heptane, toluene, etc.

Other optional components include fillers, pigments, adhesion promoters, defoamers, rheology modifiers, cure accelerators, and the like.

The first component (oxirane or oxetane functionalized or epoxidized oil) or the second component (multifunctional acid derivative or di- or tri-carboxylic acid having a pKa1 less than 3.0) with the optional ingredient is prepared by mixing and dispersing them in a high-speed mixer, planetary mixer or Brabender mixer until homogeneous. In all cases, care is taken that the first component and the second component does not come into contact with each other to prevent premature curing.

The two separate components are combined to form as a coating, adhesives, sealants, elastomer. The two separate components may combined together at room temperature, and then applied onto a substrate. This can further be coated then dried, as necessary to drive off solvent. In another embodiment, the two components, after mixing, can be dispensed onto a substrate for further manipulation, such as filling a channel or a crevice, or pressed in between two substrates to create an adhesive bond

In yet another embodiment, the separate components can be dispensed through a static mixer, having two separate chambers that mix immediately before dispensing, onto a substrate.

Substrates include flexible films including paper, polypropylene, PET, polyethylene, nylon, metalized films, metal foils, e.g., aluminum foil, stainless steel, copper; and the like. Substrates can also include rigid materials such as paperboard, wood, engineered plastic, metal, cement, tile, and the like.

Once the combined two-component is applied onto the substrate, it can cure from about one minute to about 72 hours, or even weeks if a slow cure is preferred to minimize stress build-up during cure. The curing rate can be designed by a skilled artisan to meet the desired time depending on the curing agent, accelerator, and/or temperature. The two-component curable composition can be used in packaging consumer goods, including mobile devices, computers, televisions/monitors, sealants and caulking materials, gap filler thermal interface materials, packaging, flexible packaging, food packages, laminate, pressure sensitive adhesives, and the like.

### EXAMPLES

Many modifications and variations of this invention can be made without departing from its spirit and scope, as will be apparent to those skilled in the art. The specific embodiments described herein are offered by way of example only, and the invention is to be limited only by the terms of the appended claims, along with the full scope of equivalents to which such claims are entitled.

### Example 1

### Synthesis of Diethylene Glycol-Phthalic Anhydride Adduct and Curing with ESBO

Into a 100 ml round bottom flask, 29.6 g phthalic anhydride (melting point 131-134° C., pKa1 value of 2.9 for the corresponding phthalic acid) and 10.6 g diethylene glycol were added. It was heated to about 135° C., with stirring, to melt the anhydride, and then further stirred for 60 min. A clear, highly viscous material was obtained. This product was named DEG-2PA.

¹H NMR (CDCl₃): 8.10-7.45 ppm (8H), 4.56-4.36 ppm (4H), 3.98-3.60 ppm (4H)

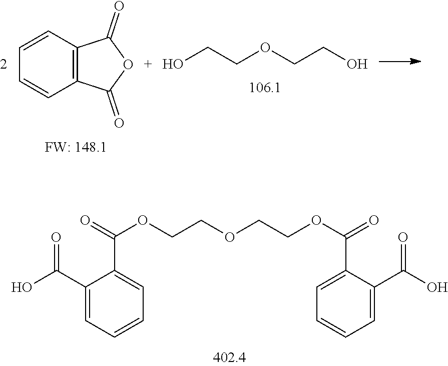

TABLE 1
Room Temperature Curing with ESBO (epoxized soybean oil)

| | #1 | #2 | #3 |
|---|---|---|---|
| Vikoflex | 9.5 | 9.5 | 4.75 |
| 7170 | | | |
| (ESBO) | | | |
| DEG-2PA | 2.0 | 2.0 | 2.0 |
| Ethyl | 2.0 | 2.0 | 2.0 |
| acetate | | | |
| Drying | Room temperature | 110° C./10 min | Room temperature |
| Curing | No cure in 7 days | No cure in 7 days | Began to cure in 10 |
| | Forms PSA-like | Forms soft, non- | days. Cured in 14 |
| | material in 3 weeks | tacky gel in 3 | days. Tack free in 3 |
| | | weeks | months. |

Phthalic acid half ester derivatives cured ESBO, and the average cure speed ranged from about 2 weeks to 3 months.

### Example 2

### Synthesis of Maleic Anhydride-DEG Adduct and Curing with ESBO

In a small jar, 1.96 g of maleic anhydride (pKa1 value of 1.9 for the corresponding maleic acid) and 1.06 g of diethylene glycol (DEG) were mixed and heated at 120° C. for 30 min. A slightly yellow solution was obtained. ¹H NMR (CDCl₃): 10.72-10.44 ppm (2H), 7.06 ppm (0.39H, residual maleic anhydride), 6.45-6.25 ppm (3.61H), 4.28-4.44 ppm (3.55H), 3.86-3.59 ppm (4.46H) indicated over 90% conversion of the maleic anhydride. This product was named DEG-2MA. ¹H NMR peaks in the 6.90-6.80 ppm region is likely from trace amounts of fumaric acid ester formed from thermal isomerization of maleic acid esters.

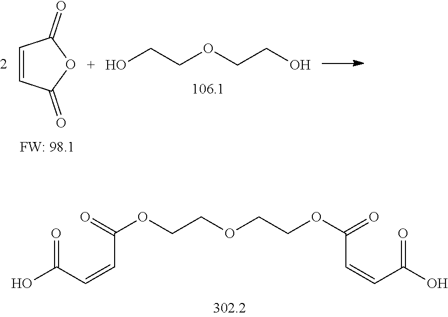

Upon cooling, 9.5 g Vikoflex 7170 was added. After mixing, a hazy solution was obtained. No gelation was observed for hours. The sample thickened in 2-3 days and began to gel in 4 days. It fully gelled in in ˜5 days. Eventually, it gelled to Shore OO hardness of 85 in about 2-3 months.

### Example 3

### Synthesis of Maleic Anhydride-HD Adduct

The above synthesis was repeated, replacing DEG with hexanediol (HD), resulting in a solid diacid which melted in 120° C.oven. This product was named HD-2MA. ¹H NMR (CDCl₃): 11.17-10.41 ppm (2.06H), 7.06 ppm (0.24H, residual maleic anhydride), 6.98-6.76 ppm (0.05H, fumaric acid ester), 6.50-6.16 ppm (3.70H), 4.36-4.11 ppm (3.71H), 3.78-3.60 ppm (0.17H), 1.87-1.17 ppm (8.00H).

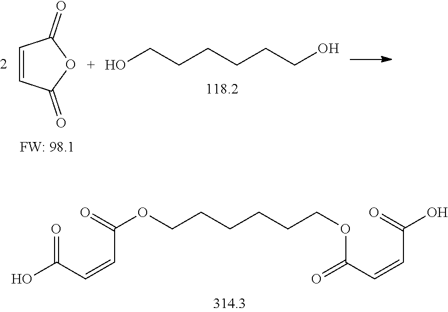

### Example 4

### Synthesis of Maleic Anhydride-MPD Adduct and Curing with ESBO

The above procedure was repeated using 3-methyl 1,5-pentanediol (MPD), the resulting product was a clear liquid and named MPD-2MA. ¹H NMR indicated 95% conversion of the maleic anhydride. ¹H NMR (CDCl₃): 11.40-11.00 ppm (2.06H), 7.06 ppm (0.21H, residual maleic anhydride), 6.90-6.80 ppm (0.03H, fumaric acid ester), 6.51-6.20 ppm (3.74H), 4.47-4.13 ppm (3.79H), 3.84-3.65 ppm (0.18H), 1.91-1.35 ppm (4.99H), 1.07-0.86 ppm (3.00H)

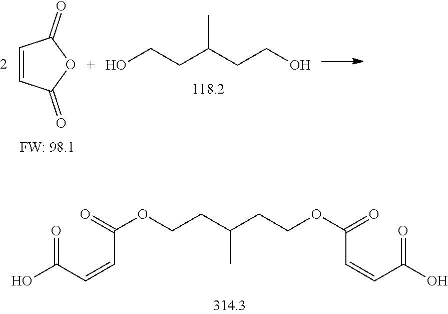

4.75 g Vikoflex 7170 was mixed with 1.58 g MPD-2MA and resulted in clear solutions. The solution began to gel in 3 days and completely gelled in 4 days. In 2 months, the cured sample was almost tack free.

### Example 5

### Synthesis of Maleic Anhydride-Dimer Diol Adduct and Curing with ESBO

The above synthesis procedure was repeated using 5.40 g dimer diol (Pripol 2033) and 1.96 g maleic anhydride at 135° C.for 1 h. The resulting product was a clear liquid and named DD-2MA. ¹H NMR (CDCl₃): 7.06 ppm (0.42H, residual maleic anhydride), 6.52-6.34 ppm (3.58H), 4.35-4.14 ppm (3.62H), 3.72-3.63 ppm (0.37H), 2.06-0.58 ppm (66.64H). This indicated ˜90% conversion of the maleic anhydride.

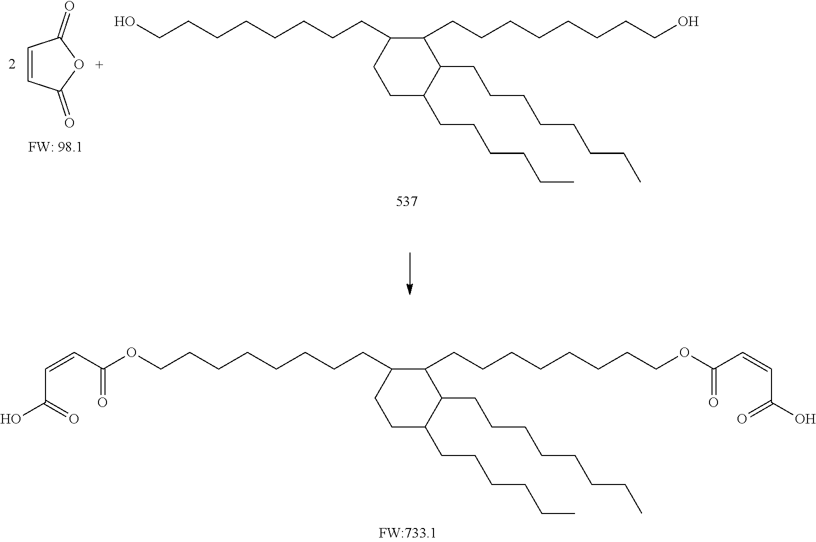

4.75 g Vikoflex 7170 was mixed with 3.68 g DD-2MA, resulting in a clear solution. This solution began to gel in 5 days and fully cured in 6 days. In 2 months, the cured sample was almost tack free.

### Example 6

### Synthesis of Maleic Anhydride-Trimethylolpropane Adduct and Curing with ESBO

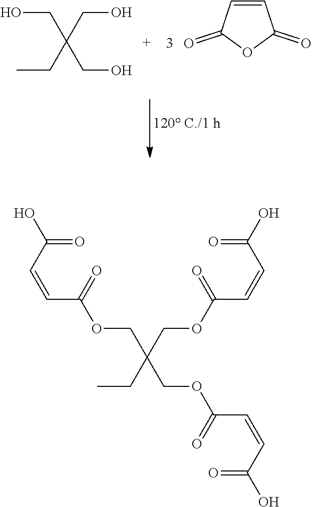

Into a glass vial, 1.34 g trimethylolpropane and 2.94 g maleic anhydride were added and heated in 130° ° C.oven for 1 h. This product was named TMP-3MA. ¹H NMR (acetone-d₆): 7.35 ppm (0.07H), 6.88-6.77 ppm (0.47H), 6.55-6.33 ppm (5.59H), 4.34-4.08 ppm (5.65H), 3.6-3.5 ppm (0.30H), 1.68-1.45 ppm (2H), 1.00-0.80 ppm (3H). Upon cooling, 9.50 g Vikoflex 7170 was added. This resulted in a slightly hazy mixture. This sample cured in 1 day to give a slightly tacky solid. In two months, it cured to a Shore D 60 opaque sample.

### Example 7

### Synthesis of Maleic Anhydride-CAPA 3031 Adduct and Curing with ESBO

In a glass vial, 3.0 g CAPA® 3031 (a polyester triol with MW˜300, EW˜100 from Perstorp) and 2.94 g maleic anhydride were added and heated in 135° C. oven for 1 h, resulted in 97% conversion of the maleic anhydride according to ¹H NMR. ¹H NMR (CDCl₃): 10.40-9.82 ppm (3.43H), 7.05 ppm (0.17H), 6.94-6.78 ppm (0.22H), 6.47-6.20 ppm (5.47H), 4.40-3.94 ppm (8.57H), 3.62-3.44 ppm (0.29H), 2.44-2.24 ppm (2.89H), 1.80-1.30 ppm (10.79H), 1.00-0.77 ppm (3.00H). This product was named CAPA3031-3MA.

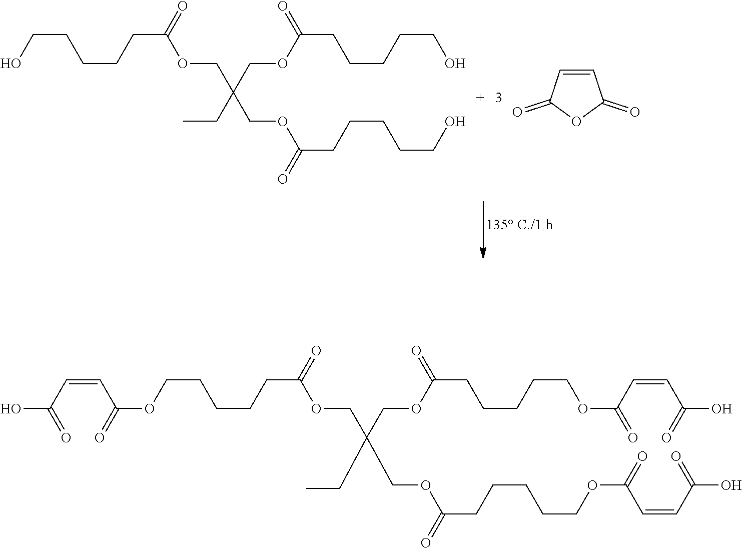

Into a 20 mL glass vial was added 3.0 g CAPA3031-3MA, and 4.75 g Vikoflex 7170. It cured to a hazy material with Shore OO of 62 in 48 h.

### Example 8

### Synthesis of Maleic Anhydride-Bis(2-hydroxyethyl) Terephthalate Adduct and Curing with ESBO

The synthesis reaction was conducted using bis(2-hydroxyethyl) terephthalate at 135° C. for 3 h, resulting in a clear & viscous liquid and about 86% conversion of the hydroxyl groups. This product was named BHETP-2MA.

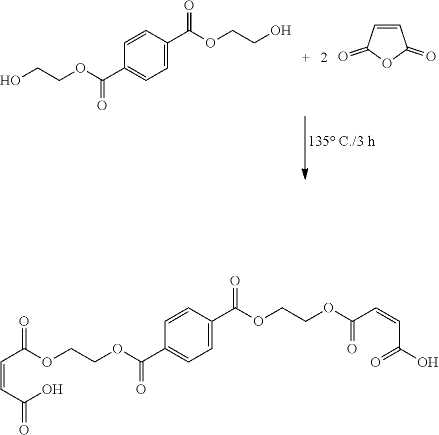

Curing was conducted using 9.5 g Vikoflex 7170 and 4.5 g BHETP-2MA. This resulted in a hazy mixture that gelled into a tacky adhesive in 3 days. At 7 days, the hardness increased to Shore OO 59 and eventually stabilize at Shore OO 76.

### Example 9

### Synthesis of Oxalic Acid-Cycloaliphatic Epoxy Adduct and Curing with ESBO

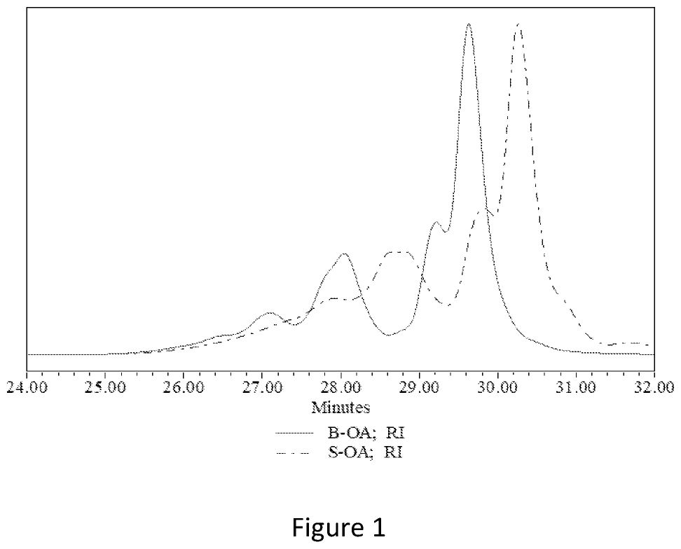

Into a speedmixer jar, 2.52 g cycloaliphatic epoxy (Syna Epoxy S-06E), 1.8 g oxalic acid (pKa1 value of 1.3), and 2.0 g methanol as a solvent were added. The acid:epoxy molar ratio was 2:1. Upon mixing, the sample became warm. It was left in vacuum oven for 4 days to remove methanol. This was further heated at 80° ° C.for 30 min in vacuum oven to remove any residual methanol. The resulting product was named S-OA. Size Exclusion Chromatography indicated that this product is a mixture of various oligomers (FIG. 1, dotted line). Afterwards, 2.16 g of the resultant S-OA was mixed with 4.75 g Vikoflex 7170. This mixture remained as a liquid in 24 h but cured in 48 h.

### Example 10

### Synthesis of Oxalic Acid-Bisphenol A Diglycidyl Ether Adduct and Curing with ESBO

Into a speedmixer jar, 3.40 g bisphenol A diglycidyl ether (Aldrich), 1.8 g oxalic acid, and 2.0 g methanol as solvent was added. Upon mixing, the sample became warm. The molar acid:epoxy ratio was 2:1. It was left in vacuum oven for 4 days to remove methanol. It was further heated at 80° C. for 30 min to remove methanol to give a clear liquid (B-OA). Size Exclusion Chromatography indicated that this product is a mixture of various oligomers (FIG. 1, solid line).

2.6 g of the resultant B-OA was mixed with 4.75 g Vikoflex 7170. This gelled in 24 h to give a tacky PSA-like material. The hardness increased to Shore OO 37 in a week.

### Example 11

### Synthesis of Urethane Epoxy and Curing with Maleic Acid Adduct

Into a speedmixing cup, 0.2 g K-KAT XK-672 (King Industries), 46.0 g polypropylene glycol-toluene diisocyanate copolymer (MW 2300, Sigma Aldrich), 2.96 g glycidol (MW 74, Sigma Aldrich) were added and mixed. After storing for 4 days at room temperature, 12.3 g this product was further mixed with 2.0 g CAPA3031-3MA adduct, resulting in a clear mixture which cured in 6 days to Shore OO of 0, and 10 day at Shore OO 22.

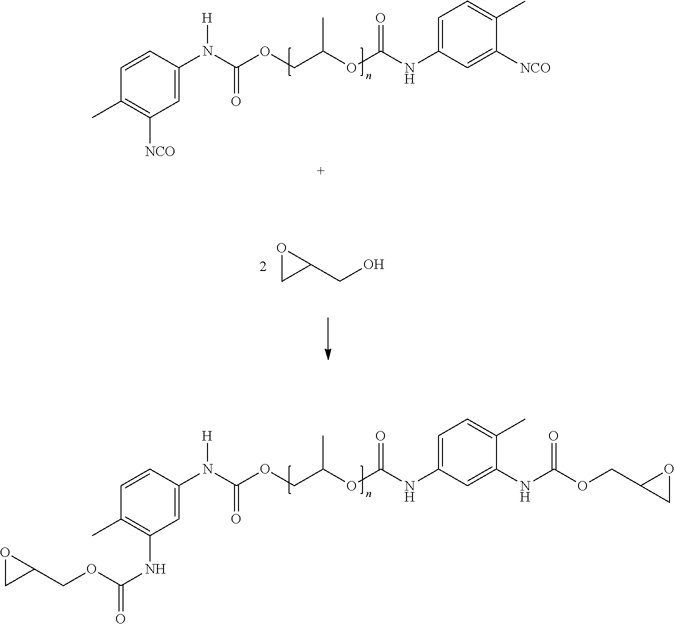

### Example 12

### Curing of Cycloaliphatic Epoxy-Maleic Acid Adduct System

Into a speed mixing cup, 6.0 g CAPA3031-3MA, 4.0 g Syna-Epoxy 06E, (3,4-Epoxycyclohexylmethyl-3,4-epoxycyclohexanecarboxylate from Synasia Inc., NJ) were added. The Syna-Epoxy 06E has epoxy equivalent weight of 130.0˜ 135.0 g/Eq, and so the epoxy to the acid ratio is about 1 to 1. This composition gelled in 15 min with noticeable exotherm reaction, and this was allowed to further cure for 24 h. This resulted in a clear and brittle piece, having Shore A hardness of 92.

### Example 13

### Curing of Epoxidized Polybutadiene-Maleic Acid Adduct System

Into a speed mixing cup, 3.14 g MPD-2MA, 5.88 g Poly bd® 605E (hydroxyl-terminated epoxidized polybutadienes from Cray Valley, EEW 294) were added. A clear and transparent mixture was obtained after mixing. Upon curing at room temperature for 2 days, a slightly tacky material with Shore OO hardness of 25 was obtained.

### Example 14

### Curing of Siloxane Epoxy-Maleic Acid Adduct System

Two blends were created to demonstrate the value of this chemistry for silane/silicone-based systems.

In one blend, 4.0 g CAPA3031-3MA, 3.8 g SIB1092.0 (1,3-bis[2-(3,4-epoxycyclohexyl)ethyl]tetramethyldisiloxane from Gelest, PA) were added to a speed cup and mixed. SIB1092.0 has epoxy equivalent weight of ˜192 g/Eq., and the epoxy to the acid ratio here is about 1 to 1. This composition gelled in 30 min with mild exotherm, and further cured in 24 h to a clear and soft piece having Shore OO hardness of 70. It had slight tack with some minor bubbles in the sample.

In another blend, 3.6 g DD-2MA, 4.3 g ECMS-924 (8-10% [(epoxycyclohexyl) ethyl] methylsiloxane-dimethylsiloxane copolymer by Gelest, PA) were added into a 20mL vial. This sample was mixed by a vortex mixer. This composition gelled within 30 min to form a soft, milky product.

### Experiment 15: Curing of Polyacrylate-Maleic Acid Adduct System

Into a 20 mL vial, 10 g epoxy functional polyacrylate (Estron experimental sample, EEW˜1000) and 2 g CAPA3031-3MA were combined and mixed. The sample was cured after 42 days to Shore OO 52.

1. A two-component curable composition comprising:
a) an oxirane or oxetane functionalized component and
b) a multifunctional acid derivative having a structure of (i) 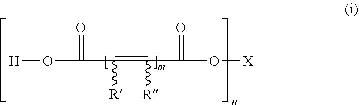
wherein R′ and R″, independently are H or R′—═—R″ is an aromatic ring, and may further contain substitutions on the aromatic ring; m=0 or 1, n is a positive integer from 2 to 100, and X is a multifunctional radical backbone, and
wherein the multifunctional acid derivative is prepared from (1) a diacid precursor having the structure of (ii), which has a pKa1 of less than 3, or (2) the corresponding anhydride of the diacid (ii)

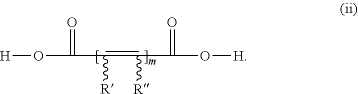

2. The two-component curable composition of claim 1, wherein the oxirane or oxetane functionalized component is selected from aliphatic or glycidyl epoxy resin.

3. The two-component curable composition of claim 1, wherein the oxirane or oxetane functionalized component has an epoxy functional group attached to a polymeric backbone selected from the group consisting of silicone, polybutadiene, 1,4-polyisoprenes, polyether, polyester, polyurethane, polycarbonate, polyacrylate, and mixtures thereof.

4. The two-component curable composition of claim 1,
wherein the multifunctional acid derivative is selected from the group consisting of oxalic acid derivative, maleic acid derivative, fumaric acid derivative phthalic acid or trimellitic acid derivative.

5. The two-component curable composition of claim 1, further comprising a tackifier, plasticizer, catalyst, curing agent, solvent or additive.

6. A two-component curable composition comprising:
a) an epoxidized oil prepared from a renewable triglyceride compound and
b) a multifunctional acid derivative having a structure of (i) 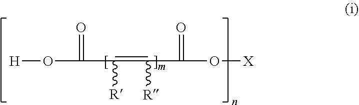
wherein R′ and R″, independently are H or R′—═—R″ is an aromatic ring, and may further contain substitutions on the aromatic ring; m=0 or 1, n is a positive integer from 2 to 100, and X is a multifunctional radical backbone, and
wherein the multifunctional acid derivative is prepared from (1) a diacid precursor having the structure of (ii), which has a pKa1 of less than 3, or (2) the corresponding anhydride of the diacid (ii)

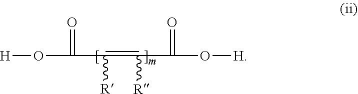

7. The two-component curable composition of claim 6,
wherein the renewable triglyceride compound is selected from the group consisting of oils from soybean, high oleic soybean, palm, rape, corn, cottonseed, linseed, linola, olive, rice, safflower, sesame, sunflower, and mixtures thereof.

8. The two-component curable composition of claim 7, wherein the renewable triglyceride compound is soybean oil, high oleic soybean oil, rape oil or palm oil.

9. The two-component curable composition of claim 6, wherein the multifunctional component is selected from the group consisting of oxalic acid, maleic acid, fumaric acid, phthalic acid, trimellitic acid, and corresponding derivatives.

10. The two-component curable composition of claim 6, further comprising a tackifier, plasticizer, catalyst, curing agent, solvent or additive.

11. A two-component curable composition comprising:
a) oxirane or oxetane functionalized component and
b) di- or tri-carboxylic acid having a pKa 1 less than 3.0 and selected from the group consisting of oxalic acid, maleic acid, fumaric acid, phthalic acid, trimellitic acid, and derivatives thereof.

12. The two-component curable composition of claim 11,
wherein the oxirane or oxetane functionalized component is selected from the group consisting of soybean, palm, rape, corn, cottonseed, linseed, linola, olive, rice, safflower, sesame, sunflower, and mixtures thereof.

13. The two-component curable composition of claim 11,
wherein the oxirane or oxetane functionalized component is selected from aliphatic epoxy resin or glycidyl epoxy resin.

14. The two-component curable composition of claim 11, further comprising a tackifier, plasticizer, catalyst, curing agent, solvent or additive.

15. The two-component curable composition of claim 11, which is an adhesive, sealant, elastomer or coating.

16. An article comprising the two-component curable composition of claim 11.

17. The article of claim 16 further comprising a substrate.

18. The article of claim 17 which is a flexible packaging, laminate or film.
